(19) United States
(12) Patent Application Publication
(10) Pub. No.: US 2025/0369492 A1
(43) Pub. Date: Dec. 4, 2025

(54) REINFORCED GUIDE ROD BOOT FOR VEHICLE DISC BRAKE APPARATUS

(71) Applicant: HL MANDO CORPORATION, Pyeongtaek-si (KR)

(72) Inventor: Satish Ramchandra KOLEKAR, Farmington, MI (US)

(21) Appl. No.: 18/678,891

(22) Filed: May 30, 2024

(51) Int. Cl. F16D 65/00

(52) U.S. Cl. CPC F16D 65/0087; F16D 65/0068

(57) ABSTRACT

A boot for a guide rod of a vehicle disc brake apparatus is configured to facilitate the retraction of brake pads from a rotor and substantially reduce brake pad drag when the brakes are released. The boot includes a tubular body with opposite first and second end portions, wherein the first end portion is configured to be secured to the guide rod and the second end portion is configured to be secured to a brake pad carrier. The guide rod extends and contracts as the brake pad carrier and caliper move relative to each other during braking operations, and the tubular body of the boot is configured to longitudinally expand and contract with the movement of the guide rod. At least one biasing member is associated with the tubular body and is configured to urge the tubular body to a contracted state.

### FIELD

The present inventive concept relates generally to vehicle brakes and, more particularly, to vehicle disc brakes.

### BACKGROUND

A vehicle disc brake system, such as a floating-type caliper brake system 10 illustrated in FIGS. 1A-1C, includes a brake disc 15 (also called a rotor) that is connected to a vehicle wheel, a caliper 22, a brake pad carrier 24, and two or more brake pads, such as an inner or inboard brake pad 32 and an outer or outboard brake pad 34 on opposing sides of the rotor 15. The brake pads 32, 34 are mounted within the brake pad carrier 24 so that the brake pads 32, 34 can move axially, along a rotor axis, a piston bore axis, or both, toward and away from the rotor 15.

For example, as illustrated in FIG. 1B, when a vehicle brake is applied by an operator of the vehicle, hydraulic fluid flows into the caliper 22 via conduit C and forces a piston (not shown) outward. This outward movement of the piston forces the inner brake pad 32 into contact with the inboard surface of the rotor 15, and also creates a rearward force that causes the caliper 22 to move axially along the guide rods 26 relative to the brake pad carrier 24 (as indicated by arrow BA in FIG. 1B) which forces the outer brake pad 34 against the opposing outboard surface of the rotor 15. Pressing the brake pads 32, 34 against the rotor 15 causes braking of the wheel. When the brake pedal is released, the hydraulic fluid flows out of the caliper 22, thereby allowing the piston to retract and release the inner brake pad 32 from contacting the rotor 15. As the piston retracts, the caliper 22 moves in the opposite direction along the guide rods 26 and relative to the brake pad carrier 24 (as indicated by arrow BR in FIG. 1C) which pulls the outer brake pad 34 away from the rotor 15, thereby allowing the rotor 15 to rotate relative to caliper 22.

There is an ongoing need to reduce residual brake drag in disc brake systems caused by unwanted contact between brake pads and a rotor in non-braking conditions. In the current market, in which manufacturers are moving towards electrification, battery life is a major focus point. In electric vehicles, drag caused by brake pads contacting a rotor when braking is not needed may reduce battery life. For example, it has been estimated that battery life may be reduced by about 0.5 mile per 1 Nm drag per disc brake caliper.

In current floating-type caliper designs, one or more springs may be utilized to assist in retracting an outer brake pad away from a rotor when the brakes are released. However, the spring retraction force may be insufficient to move the brake pad carrier and caliper away from each other such that the outer brake pad is completely retracted from the rotor. For example, when the spring retraction force is less than the sliding friction force between the rotor and the brake pads, brake drag may occur because of unwanted contact even in non-braking conditions. As such, some brake pad drag may still occur.

### SUMMARY

According to some embodiments of the present inventive concept, a boot for a guide rod of a vehicle disc brake apparatus is provided that is configured to facilitate the retraction of brake pads from a rotor and substantially reduce brake pad drag when the brakes are released. The vehicle disc brake apparatus includes a brake pad carrier and a caliper that is movably coupled to the brake pad carrier via the guide rod. The boot includes a tubular body that is configured to surround the guide rod and seal the guide rod and the vehicle disc brake apparatus from the environment and foreign substances. The tubular body includes opposite first and second end portions with the first end portion configured to be secured (e.g., scalingly secured) to the guide rod and the second end portion configured to be secured (e.g., scalingly secured) to the brake pad carrier. The guide rod moves between extended and retracted positions as the brake pad carrier and caliper move relative to each other during braking operations, and the tubular body of the boot is configured to longitudinally expand and contract with the movement of the guide rod. In some embodiments, a portion of the tubular body between the first and second end portions has a varying outer diameter that forms a bellows section which allows the tubular body to longitudinally expand and contract. At least one biasing member is associated with the tubular body and is configured to urge the tubular body to a contracted (i.e., non-extended, relaxed) state.

In some embodiments, the at least one biasing member is formed within a wall of the tubular body.

In some embodiments, the at least one biasing member includes at least one spring wire. For example, the at least one spring wire may include a plurality of spring wires arranged in substantially equal-spaced intervals around a circumference of the tubular body. In some embodiments, the plurality of spring wires may be connected together as a unit.

In some embodiments, the at least one biasing member includes at least one strip of spring material.

In some embodiments, the at least one biasing member includes spring material that circumferentially surrounds the tubular body and extends from the first end portion to the second end portion. In some embodiments, the at least one biasing member includes spring material that circumferentially surrounds the tubular body only within the bellows section.

In some embodiments, the at least one biasing member includes spring material with a polymeric cladding, such as ethylene propylene diene monomer (EPDM) cladding, for example.

According to some embodiments of the present inventive concept, a boot for a guide rod of a vehicle disc brake apparatus is provided that is configured to facilitate the retraction of brake pads from a rotor and substantially reduce brake pad drag when the brakes are released. The vehicle disc brake apparatus includes a brake pad carrier and a caliper that is movably coupled to the brake pad carrier via the guide rod. The boot includes a tubular biasing member configured to surround the guide rod. The tubular biasing member includes opposite first and second end portions, wherein the first end portion is configured to be secured to the guide rod and the second end portion is configured to be secured to the brake pad carrier. The tubular biasing member is configured to longitudinally expand and contract with movement of the guide rod, and to urge the guide rod to a retracted position.

In some embodiments, the first end portion of the tubular biasing member includes a polymeric material formed therearound, and the second end portion of the tubular biasing member includes a polymeric material formed therearound.

In some embodiments, a portion of the tubular biasing member between the first and second end portions has a varying outer diameter that forms a bellows section.

In some embodiments, the tubular biasing member includes spring material with a polymeric cladding.

According to embodiments of the present inventive concept, a vehicle disc brake apparatus includes a brake pad carrier configured to be secured to a vehicle frame or body, a caliper movably coupled to the brake pad carrier via a guide rod, and a boot mounted on the guide rod that is configured to seal the guide rod and the vehicle disc brake apparatus from the environment and foreign substances. The guide rod has one end secured to the caliper and an opposite end that is movably coupled to the brake pad carrier.

The boot includes a tubular body that surrounds the guide rod and includes opposite first and second end portions. The first end portion is secured (e.g., sealingly secured) to the guide rod and the second end portion is secured (e.g., sealingly secured) to the brake pad carrier. The tubular body is configured to longitudinally expand and contract with movement of the guide rod. For example, a portion of the tubular body between the first and second end portions has a varying outer diameter that forms a bellows section which allows the tubular body to longitudinally expand and contract. At least one biasing member is associated with the tubular body and is configured to urge the tubular body to a contracted (i.e., non-extended, relaxed) state.

In some embodiments, the at least one biasing member is formed within a wall of the tubular body. In some embodiments, the at least one biasing member may be secured to an inner and/or outer surface of the tubular body.

In some embodiments, the at least one biasing member includes at least one spring wire. For example, the at least one spring wire may include a plurality of spring wires arranged in substantially equal-spaced intervals around a circumference of the tubular body.

In some embodiments, the at least one biasing member includes spring material that circumferentially surrounds the tubular body and extends from the first end portion to the second end portion. In some embodiments, the at least one biasing member includes spring material that circumferentially surrounds the tubular body only within the bellows section.

Guide rod boots, according to embodiments of the present inventive concept, are advantageous because, in addition to sealing the guide rods and the vehicle disc brake apparatus from the environment and foreign substances, they can also facilitate the retraction of brake pads away from a rotor, thereby substantially reducing drag. As such, electric vehicles incorporating the vehicle disc brake apparatus with the guide rod boots of the present inventive concept may achieve longer battery life than electric vehicles with conventional vehicle disc brake apparatus.

It is noted that aspects of the present inventive concept described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present inventive concept are explained in detail below.

### BRIEF DESCRIPTION OF THE DRAWINGS

The accompanying drawings, which form a part of the specification, illustrate various embodiments of the present inventive concept. The drawings and description together serve to fully explain embodiments of the present inventive concept.

FIGS. 1A-1C are perspective views of a conventional floating-type caliper brake system for a vehicle.

FIG. 2 is a perspective view of a vehicle disc brake apparatus, according to some embodiments of the present inventive concept.

FIG. 3 is an enlarged partial view of a portion of a guide rod and boot of the vehicle disc brake apparatus of FIG. 2.

FIG. 4A is a cutaway perspective view of a guide rod boot with a biasing element within the wall thereof, according to some embodiments of the present inventive concept.

FIG. 4B is a cutaway perspective view of a guide rod boot with a biasing element within the wall thereof, according to some embodiments of the present inventive concept.

FIG. 5A is a perspective view of a biasing element, according to some embodiments of the present inventive concept.

FIG. 5B is a cutaway view of the biasing element of FIG. 5A.

FIG. 6 is a perspective view of a guide rod boot shown in phantom with the biasing element of FIGS. 5A-5B secured thereto, according to some embodiments of the present inventive concept.

FIG. 7A is a perspective view of a guide rod boot, according to some embodiments of the present inventive concept.

FIG. 7B is a cutaway view of the guide rod boot of FIG. 7A.

FIG. 8 is a perspective view of a spring wire that may be incorporated into a guide rod boot, according to some embodiments of the present inventive concept.

FIG. 9 is a perspective view of a guide rod boot shown in phantom including a plurality of the spring wires of FIG. 8 in substantially equal-spaced intervals around a circumference of the guide rod boot, according to some embodiments of the present inventive concept.

FIG. 10 is a perspective view of a plurality of the spring wires of FIG. 8 connected together as a single unit, according to some embodiments of the present inventive concept.

FIG. 11A is a perspective view of a guide rod boot shown in phantom including a plurality of spring wires connected together as a single unit and within the wall of the guide rod boot, according to some embodiments of the present inventive concept.

FIG. 11B is a cutaway view of the guide rod boot of FIG. 11A.

### DETAILED DESCRIPTION

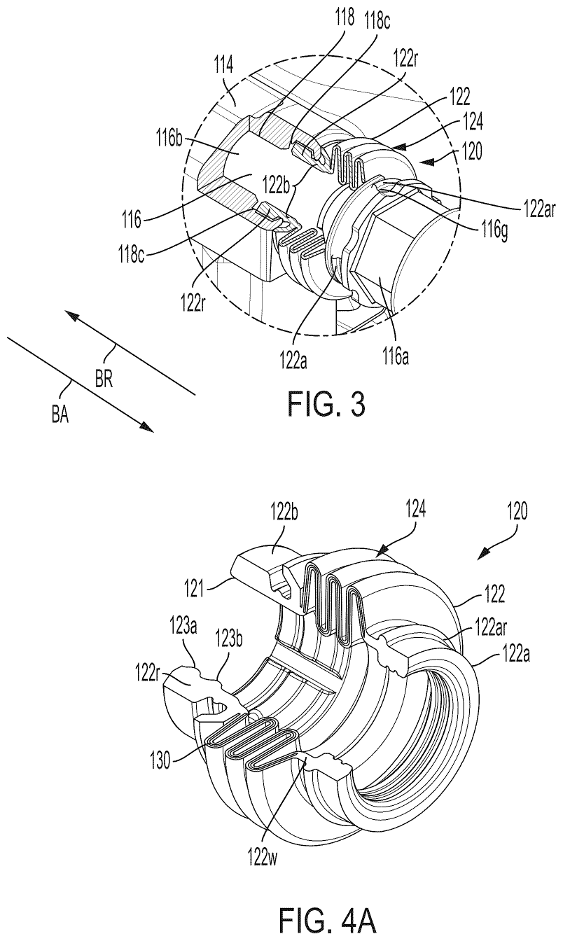

Referring initially to FIGS. 2 and 3, a vehicle disc brake apparatus 100, according to some embodiments of the present inventive concept, is illustrated. The illustrated vehicle disc brake apparatus 100 is a floating-type caliper apparatus and includes a brake pad carrier 114, a caliper 112 movably coupled to the brake pad carrier 114 via a pair of guide rods 116, and a guide rod boot 120 mounted on each of the guide rods 116. The guide rod boots 120 are configured to seal the guide rods 116 and the vehicle disc brake apparatus 100 from the environment and foreign substances. In addition, and as described herein, each guide rod boot 120 is configured to act like a spring under tension and create a spring force, when stretched from a contracted/relaxed position, that is sufficient to return the guide rod boot 120 to the contracted/relaxed position. The vehicle disc brake apparatus 100 also includes a pair of brake pads 132, 134 supported by the brake pad carrier 114 and that are spaced apart from each other such that a rotor associated with a vehicle wheel (not shown) can be positioned therebetween. The caliper 112 is movably coupled to the brake pad carrier 114 via the guide rods 116. Each guide rod 116 has a head portion 116a secured to the caliper 112 and a guide shaft portion 116b slidably inserted within a respective guide hole or passageway 118 in the brake pad carrier 114. The caliper 112 houses a piston (not shown) that is configured to advance and retreat in response to braking hydraulic pressure, and the like. The vehicle disc brake apparatus 100 performs braking of a wheel as the piston presses the inner pad 132 against the rotor and the caliper 112 slides from the brake pad carrier 114 by a reaction force against the pressing to press the outer pad 134 toward the rotor. The movement of the caliper 112 and brake pad carrier 114 relative to each other during braking causes each guide rod 116 to move to an extended position which causes each guide rod boot 120 to be longitudinally stretched to an extended position from a contracted/relaxed position.

Each guide rod boot 120 includes a tubular body 122 having a hollow center that is configured to surround the guide shaft portion 116b of a respective guide rod 116 and is configured to prevent the inflow of foreign substances (e.g., dust, water, etc.) into the passageway 118. The tubular body 122 may be formed from a resilient material, such as rubber or another polymeric material and may be configured to be resistant to moisture, oil, other contaminants, and heat. The tubular body 122 includes opposite first and second end portions 122a, 122b, and an expandable and contractable portion between the first and second end portions 122a, 122b. Each of the first and second end portions 122a, 122b has a ring shape. The first end portion 122a of the tubular body 122 is secured to the guide rod 116. For example, the first end portion 122a includes an annular rib 122ar (FIG. 3) that is configured to be received within a locking groove 116g formed in the head portion 116a of the guide rod 116. The first end portion 122a may be fixedly secured to the guide rod 116 by being press-fit into the locking groove 116g of the guide rod 116, as would be understood by one of skill in the art of the present inventive concept. However, embodiments of the present inventive concept are not limited to the illustrated way the guide rod boot 120 is secured to each guide rod 116. Various ways of securing each guide rod boot 120 to a respective guide rod 116 may be utilized, as would be understood by one of skill in the art of the present inventive concept.

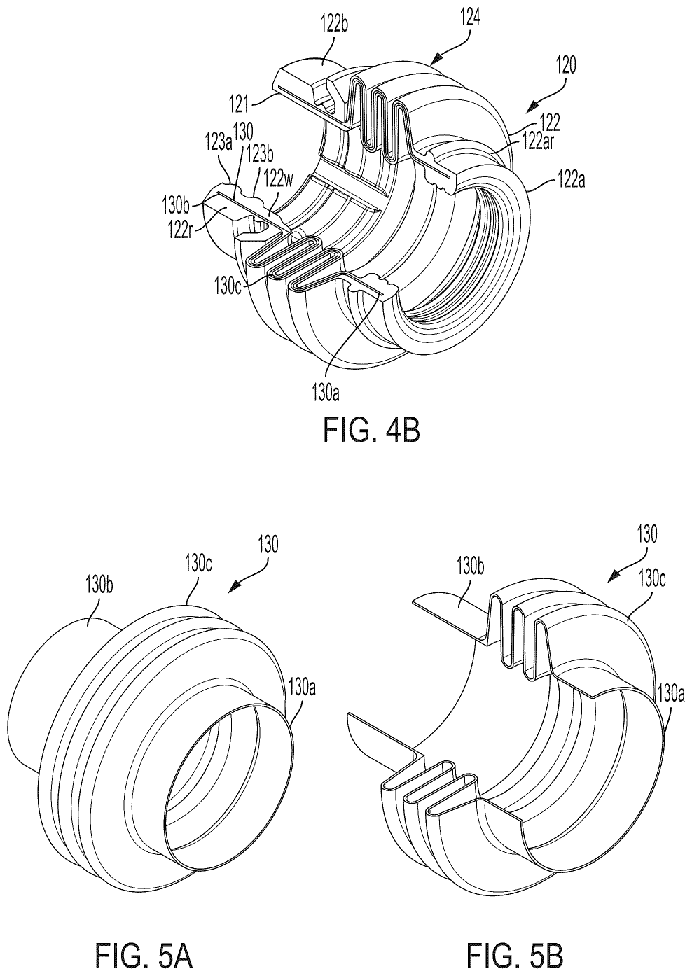

The opposite second end portion 122b is secured to the brake pad carrier 114 and is also configured to be in contact with an outer surface of guide rod 116 (i.e., the outer surface of the guide shaft portion 116b) in order to provide a sealing function. In the illustrated embodiment, the second end portion 122b of the tubular body 122 includes a pair of annular scaling rings or ribs 123a, 123b (FIGS. 4A-4B) extending outwardly from the inner surface 121 of the second end portion 122b. These sealing ribs 123a, 123b engage the outer surface of the guide shaft portion 116b to provide the sealing function, as would be understood by one of skill in the art of the present inventive concept. Although two sealing ribs 123a, 123b are provided in the illustrated embodiment, it is to be understood that more than two sealing ribs, and even a single scaling rib, may be utilized, without limitation. In the illustrated embodiment, the second end portion 122b also includes an annular protrusion or rib 122r that is received within a corresponding annular groove or channel 118c formed within a wall of the passageway 118 to secure the guide rod boot 120 to the brake pad carrier 114. However, embodiments of the present inventive concept are not limited to the illustrated way the guide rod boot 120 is secured to the brake pad carrier 114. Various ways of securing each guide rod boot 120 to the brake pad carrier 114 may be utilized, as would be understood by one of skill in the art of the present inventive concept.

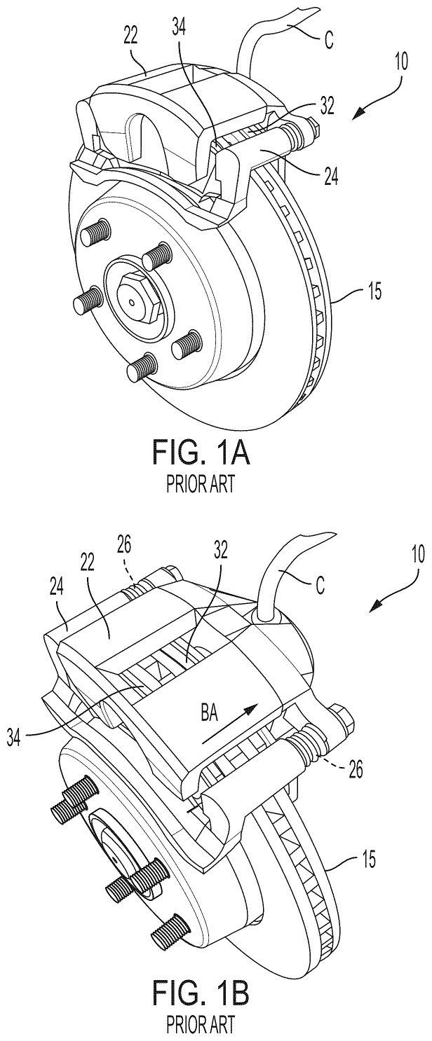

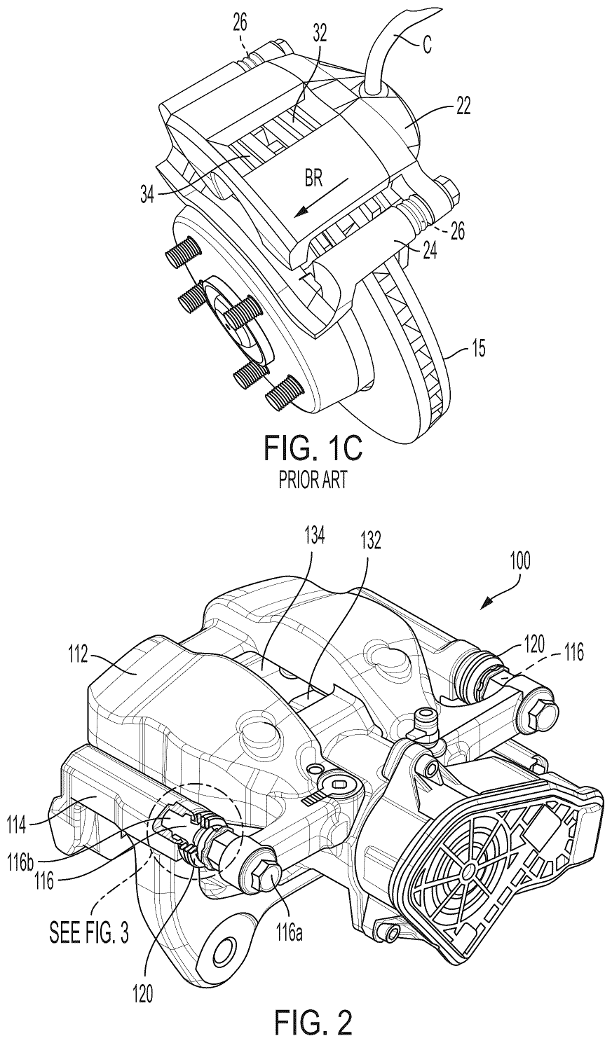

In the illustrated embodiment, the expandable and contractable portion of the tubular body 122 between the first and second end portions 122a, 122b has a varying outer diameter that forms a bellows section 124. The bellows section 124 allows the tubular body 122 to longitudinally expand and contract with movement of the guide rod 116. At least one biasing member (e.g., a spring), designated as 130 in FIGS. 4A-4B, is associated with the tubular body 122 and is configured to urge the tubular body 122 to a relaxed or contracted state after being moved to a longitudinally extended state during a braking operation. For example, during braking, each guide rod 116 moves together with the caliper 112 in the direction BA (FIG. 3) which causes each guide rod boot 120, and the at least one biasing member 130 associated with each guide rod boot 120, to move to an extended position. The extension of each guide rod boot 120 and the at least one biasing member 130 associated therewith creates a force on the at least one biasing member 130 such that, when braking is released, a reaction spring force is applied by the at least one biasing member 130 wanting to return to its relaxed or contracted state in the direction BR (FIG. 3). This reaction spring force is applied to each guide rod 116 and to the caliper 112, which moves the brake pads 132, 134 away from the rotor (i.e., the rotor 15 in FIGS. 1A, 1B, and 1C) when a braking operation is over.

For example, when a vehicle operator presses a brake pedal within the vehicle, hydraulic fluid is caused to flow into the caliper 112 and push a piston (not shown), which pushes an inner brake pad 132 into contact with a surface of a rotor (i.e., the rotor 15 in FIGS. 1A, 1B, and 1C). This braking operation causes the caliper 112 and each guide rod 116 to move, which causes each guide rod boot 120 to longitudinally expand and, thereby, each biasing member 130 associated with each guide rod boot 120 to stretch or extend creating a spring force in each biasing member 130. This spring force is imparted to each guide rod 116 because each guide rod boot 120 is attached to a respective guide rod 116 and this causes the caliper 112 to move away from the rotor when a braking operation is over. In other words, because the head portion 116a of each guide rod 116 is secured to the caliper 112, as the caliper 112 moves during braking, the guide rod 116 is moved outward from the passageway 118 (i.e., in the direction BA, FIG. 3). This outward movement causes each guide rod boot 120, and each biasing member 130 associated therewith, to longitudinally expand, thereby creating a spring force. Upon the removal of the braking force, the at least one biasing member 130 associated with each guide rod boot 120 urges the tubular body 122 of each guide rod boot 120 toward a contracted state (i.e., non-extended or relaxed state), which urges the guide shaft portion 116b of the guide rod 116 back into the passageway 118 (i.e., in the direction BR, FIG. 3). Thus, a guide rod boot 120 for a caliper brake, according to an embodiment of the present inventive concept, and a caliper brake including the same, can substantially reduce or eliminate a brake pad drag phenomenon by generating a reaction force in the guide rod boot 120 during braking to move the caliper 112 to its original position prior to braking, thereby moving the brake pads 132, 134 away from the rotor when a braking operation is ended.

Various types and configurations of biasing members may be utilized with the guide rod boot 120 of the present inventive concept. For example, as illustrated in FIG. 4A, the biasing member 130 is a spring material, such as spring steel, etc., and is formed within the wall 122w of the tubular body 122 of the guide rod boot 120, for example via a molding process. The spring material may extend circumferentially around the tubular body 122 in some embodiments. In the illustrated embodiment of FIG. 4A, the biasing member 130 is positioned within the wall 122w of the tubular body 122 only within the bellows section 124. The biasing member 130 of FIG. 4A is formed with corrugations or undulations to match the shape of the bellows section 124 of the guide rod boot 120 such that, during molding operations, the biasing member 130 can be positioned precisely within the wall 122w of the bellows section 124 of the guide rod boot 120. The method of manufacturing the present invention may include 1) forming the tubular body 122 extending around the stretched biasing member 130 and 2) collapsing the tubular body 122 and the stretched biasing member 130 together to form a specific desired shape. The biasing member 130 of FIG. 4A is configured to act similar to a spring under tension when stretched such that, when a braking operation is over, the biasing member 130 is configured to return to a relaxed configuration as a result of spring force.

In other embodiments, as illustrated in FIG. 4B, the biasing member 130 is a spring material, such as spring steel, etc., formed within the wall 122w of the tubular body 122 and extending circumferentially around the tubular body 122 from the first end portion 122a of the tubular body 122 to the second end portion 122b of the tubular body 122. Specifically, the biasing member 130 illustrated in FIG. 4B includes opposite first and second end portions 130a, 130b, each having a ring shape that match the ring shape of corresponding end portions 122a, 122b of the tubular body 122 of the guide rod boot 120. In addition, the biasing member 130 illustrated in FIG. 4B includes a section 130c between the first and second end portions 130a, 130b with undulations that match the shape of the bellows section 124 of the guide rod boot 120. As such, during molding operations, the biasing member 130 illustrated in FIG. 4B can be positioned precisely within the wall 122w of the guide rod boot 120 from end portion 122a to end portion 122b. The method of manufacturing the present invention may include 1) forming the tubular body 122 extending around the stretched biasing member 130 and 2) collapsing the tubular body 122 and the stretched biasing member 130 together to form a specific desired shape. The biasing member 130 of FIG. 4B is configured to act similar to a spring under tension when stretched such that, when a force causing the biasing member to become extended or stretched (e.g., during a braking operation) is removed (e.g., when a braking operation is over), the biasing member 130 is configured to return to a relaxed configuration as a result of spring force.

Embodiments of the present inventive concept are not limited to the illustrated biasing member embodiments of FIGS. 4A and 4B. A biasing member 130 may be positioned in various locations, including multiple locations, along the longitudinal length of the guide rod boot 120. In other embodiments, the biasing member 130 of both FIG. 4A and FIG. 4B can be attached to an inner surface and/or an outer surface of the tubular body 122 and need not be molded within the wall 122w of the tubular body 122.

In some embodiments, the biasing member 130 may include multiple strips of spring material positioned within the wall 122w of the tubular body 122 in circumferentially and/or longitudinally spaced-apart relationship.

FIGS. 5A-5B illustrate a biasing member 130 that is spring steel clad on both sides with an elastomeric material, such as ethylene propylene diene monomer (EPDM). The biasing member 130 illustrated in FIGS. 5A-5B includes opposite first and second end portions 130a, 130b, each having a ring shape that match the ring shape of corresponding end portions 122a, 122b of the tubular body 122 of the guide rod boot 120 of FIGS. 4A-4B. In addition, the biasing member 130 illustrated in FIGS. 5A-5B includes a section 130c between the first and second end portions 130a, 130b with undulations that match the shape of the bellows section 124 of the guide rod boot 120. The biasing member 130 illustrated in FIGS. 5A-5B is configured to act similar to a spring under tension when stretched such that, when a force causing the biasing member 130 to become extended or stretched (e.g., during a braking operation) is removed (e.g., when a braking operation is over), the biasing member 130 is configured to return to a relaxed configuration as a result of spring force.

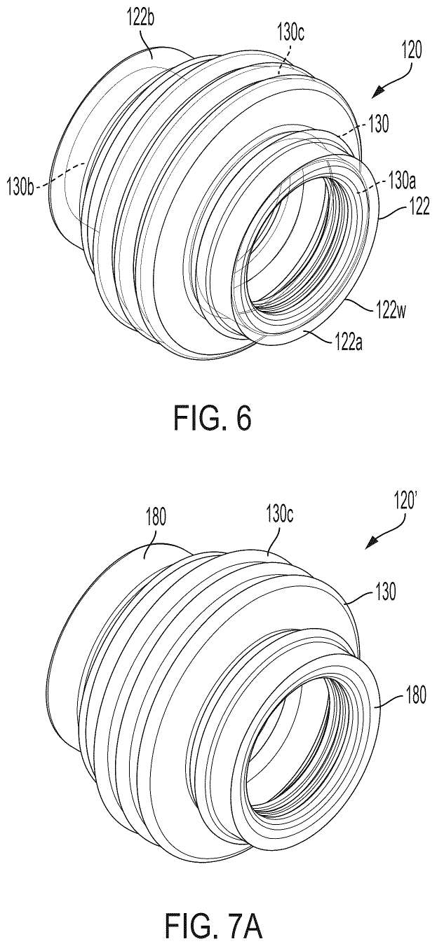

The illustrated biasing member 130 of FIGS. 5A-5B can be formed within a guide rod boot 120, as illustrated in FIG. 6, for example via a molding process. FIG. 6 is a perspective view of a guide rod boot 120 shown in phantom with the biasing element 130 of FIGS. 5A-5B formed within a wall 122w of the guide rod boot 120. During molding operations, the biasing member 130 illustrated in FIGS. 5A-5B can be positioned precisely within the wall 122w of the guide rod boot 120 from end portion 122a to end portion 122b. The method of manufacturing the present invention may include 1) forming the tubular body 122 extending around the stretched biasing member 130 and 2) collapsing the tubular body 122 and the stretched biasing member 130 together to form a specific desired shape. Alternatively, the biasing member 130 of FIGS. 5A-5B can be attached to an inner surface and/or an outer surface of the tubular body 122 and need not be molded within the wall 122w of the tubular body 122 of a guide rod boot 120. In further embodiments, the biasing member 130 of FIGS. 5A-5B could itself serve the function of the guide rod boot 120 and without requiring a separate tubular body (e.g., the tubular body 122).

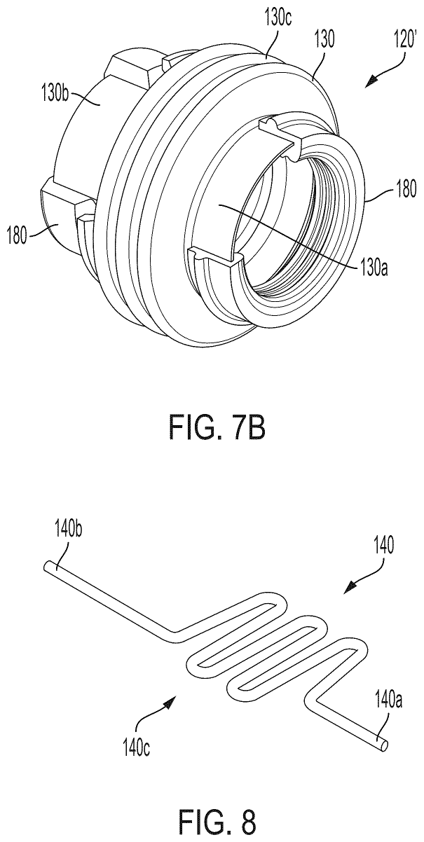

Referring to FIGS. 7A-7B, a guide rod boot 120′, according to some embodiments of the present inventive concept is illustrated. The guide rod boot 120′ includes a biasing member 130 (i.e., a tubular biasing member 130 clad on both sides with an elastomeric material, such as EPDM), as described above with respect to FIGS. 5A-5B, that is configured to surround a guide rod 116. The tubular biasing member 130 includes opposite first and second end portions 130a, 130b and a section 130c between the first and second end portions 130a, 130b with undulations that serve the function of a spring. Thus, the biasing member 130 illustrated in FIGS. 7A-7B is configured to act similar to a spring under tension when stretched such that, when a force causing the biasing member 130 to become extended or stretched (e.g., during a braking operation) is removed (e.g., when a braking operation is over), the biasing member 130 is configured to return to a relaxed configuration as a result of spring force.

The first end portion 130a includes a polymeric material 180 formed therearound (e.g., molded therearound and secured to the first end portion 130a, etc.) that is configured to secure the first end portion 130a to a guide rod 116. For example, the polymeric material 180 surrounding the first end portion 130a of the biasing member 130 may include an annular rib that is configured to be received within a locking groove formed in the head portion 116a of a guide rod 116, as described above. The second end portion 130b includes a polymeric material 180 formed therearound (e.g., molded therearound and secured to the second end portion 130b, etc.) that is configured to secure the second end portion 130b to the brake pad carrier 114. For example, the polymeric material 180 surrounding the second end portion 130b of the biasing member 130 may include an annular protrusion or rib that is received within a corresponding annular groove or channel 118c formed within a wall of the passageway 118 to secure the guide rod boot 120 to the brake pad carrier 114, as described above. In addition, the polymeric material 180 surrounding the second end portion 130b of the biasing member 130 may include one or more annular sealing rings or ribs extending outwardly from the inner surface thereof and that are configured to engage the outer surface of the guide shaft portion 116b of a guide rod 116, as described above. The polymeric material 180 at the first and second end portions 130a, 130b may be configured to be resistant to moisture, oil, other contaminants, and heat.

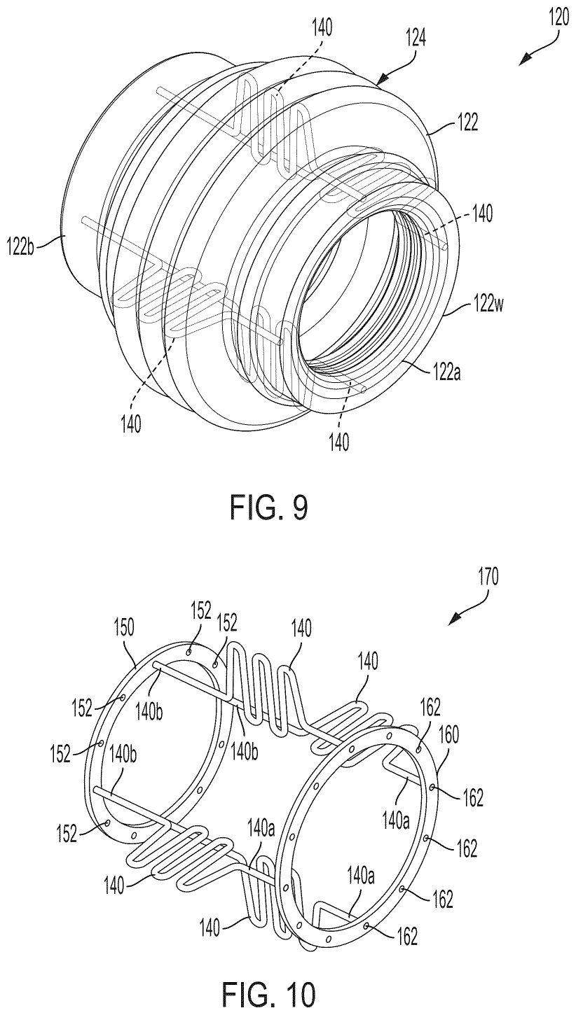

In some embodiments, as illustrated in FIGS. 8-9, a biasing member may be one or more spring wires 140 formed within the wall 122w of the tubular body 122, as described below. The spring wire 140 illustrated in FIG. 8 has a shape that corresponds to the shape of the tubular body 122 in FIGS. 4A-4B. That is, the spring wire 140 has opposite straight end portions 140a, 140b that correspond to the end portions 122a, 122b of the tubular body 122, and a portion 140c between the straight end portions 140a, 140b has undulations that correspond to the shape of the bellows section 124 of the tubular body 122. However, the spring wire 140 may have various configurations, including even a single undulation, and is not limited to the illustrated configuration. The undulations in the spring wire 140 cause the spring wire 140 to act like a spring under tension when stretched such that, when a force causing the spring wire 140 to become extended or stretched (e.g., during a braking operation) is removed (e.g., when a braking operation is over), the spring wire 140 is configured to return to a relaxed configuration as a result of spring force.

The spring wire 140 may be formed from spring steel or other similar material. In some embodiments, the spring wire 140 may be clad with an elastomeric material, such as EPDM.

In FIG. 9, a guide rod boot 120 is shown in phantom with multiple spring wires 140 formed within the wall 122w of the tubular body 122 of the guide rod boot 120, for example via a molding process. The method of manufacturing the present invention may include 1) forming the tubular body 122 extending around the stretched multiple spring wires 140 and 2) collapsing the tubular body 122 and the stretched multiple spring wires 140 together to form a specific desired shape. The multiple spring wires 140 may be arranged in substantially equal-spaced intervals around a circumference of the tubular body 122, as illustrated. In some embodiments, the multiple spring wires 140 may be connected together as a single unit 170, as illustrated in FIG. 10, to facilitate maintaining the desired orientation and positioning of the spring wires 140 during a molding process for the guide rod boot 120. In the illustrated embodiment, there are four spring wires 140 in substantially equal-spaced intervals around a circumference of the tubular body 122. However, embodiments of the present inventive concept are not limited to the illustrated number of spring wires 140. Various other numbers of spring wires 140 may be utilized in equal-spaced relationship, e.g., 3, 5, 6, 8, 10, 12, etc.

The tubular body 122 of the guide rod boot 120 has a hollow center that is configured to surround the guide shaft portion 116b of a respective guide rod 116 and is configured to prevent the inflow of foreign substances (e.g., dust, water, etc.) into the passageway 118. The tubular body 122 may be formed from a resilient material, such as rubber or another polymeric material and may be configured to be resistant to moisture, oil, other contaminants, and heat. The tubular body 122 includes opposite first and second end portions 122a, 122b, and an expandable and contractable portion between the first and second end portions 122a, 122b. Each of the first and second end portions 122a, 122b has a ring shape. The first end portion 122a of the tubular body 122 is configured to be secured to the guide rod 116. For example, the first end portion 122a may include an annular rib that is configured to be received within a locking groove 116g (FIG. 3) formed in the head portion 116a of a guide rod 116, as described above. The opposite second end portion 122b is configured to be secured to the brake pad carrier 114. For example, the second end portion 122b may include an annular protrusion or rib that is received within a corresponding annular groove or channel, as described above. In addition, the second end portion 122b may include one or more annular sealing rings or ribs extending outwardly from the inner surface thereof and that are configured to engage the outer surface of the guide shaft portion 116b of a guide rod 116, as described above. The tubular body 122 may be formed from rubber or other elastomeric polymer material that is resistant to moisture, oil, other contaminants, and heat.

The guide rod boot 120 of FIG. 9 acts like a spring under tension when stretched such that, when a force causing the guide rod boot 120 to become extended or stretched (e.g., during a braking operation and a guide rod 116 is extended) is removed (e.g., when a braking operation is over), the guide rod boot 120 is configured to return to a relaxed configuration as a result of a spring force in each of the spring wires 140 therein.

Referring to FIG. 10, a single unit 170 of spring wires 140, according to some embodiments of the present inventive concept, includes a first support ring 150 and a second support ring 160. The first support ring 150 includes a plurality of circumferentially spaced apart apertures 152, and the second support ring 160 includes a plurality of circumferentially spaced apart apertures 162. Each aperture 152 in the first support ring 150 is configured to receive an end portion 140b of a respective spring wire 140, and each aperture 162 in the second support ring 150 is configured to receive an end portion 140a of a respective spring wire 140. The first and second support rings 150, 160 hold the spring wires 140 in equal-spaced relationship. The first and second support rings 150, 160 may be formed from various materials, including steel or other metals, as well as polymeric materials. In the illustrated embodiment, four spring wires 140 are supported by the support rings 150, 160. However, embodiments of the present inventive concept are not limited to the illustrated number of spring wires 140. Various other numbers of spring wires 140 may be supported by the first and second support rings 150, 160 in equal-spaced relationship, e.g., 3, 5, 6, 8, 10, 12, etc.

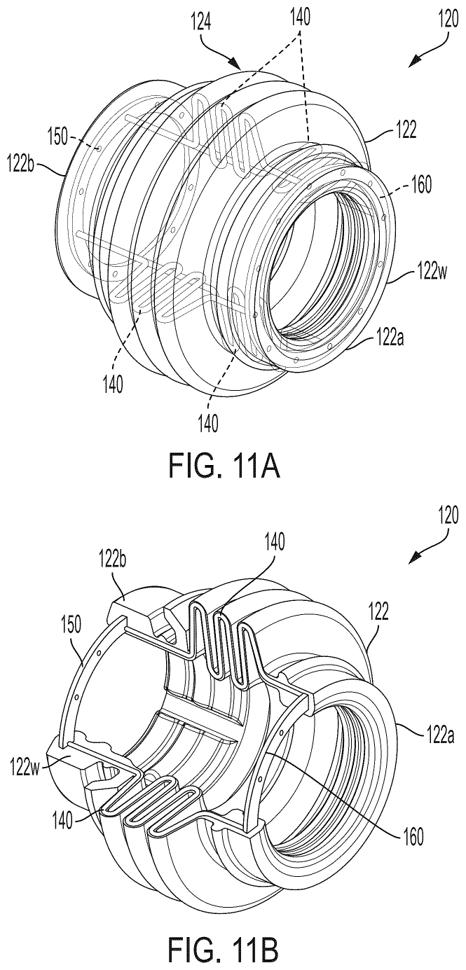

The single unit 170 of spring wires illustrated in FIG. 10 is configured to be molded within a guide rod boot 120. FIG. 11A is a perspective view of a guide rod boot 120 shown in phantom with the single unit 170 of spring wires 140 of FIG. 10 embedded within a wall 122w of the tubular body 122 of the guide rod boot 120. FIG. 11B is a cutaway view of the guide rod boot 120 of FIG. 11A that illustrates the spring wires 140 embedded within the wall 122w of the tubular body 122.

The guide rod boot 120 of FIG. 10 with the embedded single unit 170 of spring wires 140 acts like a spring under tension when stretched such that, when a force causing the guide rod boot 120 to become extended or stretched (e.g., during a braking operation and a guide rod 116 is extended) is removed (e.g., when a braking operation is over), the guide rod boot 120 is configured to return to a relaxed configuration as a result of a spring force in each of the spring wires 140 therein.

Guide rod boots 120, 120′ for caliper brakes, as described herein, can substantially reduce or eliminate a brake pad drag phenomenon by generating a reaction force of the guide rod boot 120, 120′ during braking to move a caliper 112 to its original position prior to braking, thereby moving the brake pads 132, 134 away from the rotor when a braking operation is ended. These guide rod boots 120, 120′ improve outboard pad assembly return performance and decrease drag amount contribution from the outer pad assembly. Moreover, overall performance of a caliper brake can be improved in addition to increasing brake pad life.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another clement, it can be directly on the other element or intervening elements may also be present. In contrast, when an element is referred to as being “directly on” another clement, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

What is claimed:

1. A boot for a guide rod of a vehicle disc brake apparatus, the vehicle disc brake apparatus including a brake pad carrier and a caliper movably coupled to the brake pad carrier via the guide rod, the boot comprising:
a tubular body configured to surround the guide rod, the tubular body comprising opposite first and second end portions, wherein the first end portion is configured to be secured to the guide rod and the second end portion is configured to be secured to the brake pad carrier, wherein the tubular body is configured to longitudinally expand and contract with movement of the guide rod; and
at least one biasing member associated with the tubular body, wherein the at least one biasing member is configured to urge the tubular body to a contracted state.

2. The boot of claim 1, wherein the at least one biasing member is formed within a wall of the tubular body.

3. The boot of claim 2, wherein the at least one biasing member comprises at least one spring wire.

4. The boot of claim 3, wherein the at least one spring wire comprises a plurality of spring wires arranged in substantially equal-spaced intervals around a circumference of the tubular body.

5. The boot of claim 2, wherein the at least one biasing member comprises at least one strip of spring material.

6. The boot of claim 2, wherein the at least one biasing member comprises spring material that circumferentially surrounds the tubular body and extends from the first end portion to the second end portion.

7. The boot of claim 1, wherein a portion of the tubular body between the first and second end portions has a varying outer diameter that forms a bellows section.

8. The boot of claim 1, wherein the tubular body comprises an elastomeric material.

9. The boot of claim 1, wherein the at least one biasing member comprises spring material with a polymeric cladding.

10. The boot of claim 1, wherein the first end portion is configured to be sealingly secured to the guide rod and the second end portion is configured to be sealingly secured to the brake pad carrier.

11. A boot for a guide rod of a vehicle disc brake apparatus, the vehicle disc brake apparatus including a brake pad carrier and a caliper movably coupled to the brake pad carrier via the guide rod, the boot comprising:
a tubular biasing member configured to surround the guide rod, the tubular biasing member comprising opposite first and second end portions, wherein the first end portion is configured to be secured to the guide rod and the second end portion is configured to be secured to the brake pad carrier, wherein the tubular biasing member is configured to longitudinally expand and contract with movement of the guide rod, and wherein the tubular biasing member is configured to urge the guide rod to a retracted position.

12. The boot of claim 11, wherein the first end portion of the tubular biasing member comprises a polymeric material formed therearound, and the second end portion of the tubular biasing member comprises a polymeric material formed therearound.

13. The boot of claim 11, wherein a portion of the tubular biasing member between the first and second end portions has a varying outer diameter that forms a bellows section.

14. The boot of claim 11, wherein the tubular biasing member comprises spring material with a polymeric cladding.

15. A vehicle disc brake apparatus, comprising:
a brake pad carrier;
a caliper movably coupled to the brake pad carrier via a guide rod, wherein the guide rod has one end secured to the caliper and an opposite end that is movably coupled to the brake pad carrier; and
a boot mounted on the guide rod, the boot comprising:
a tubular body that surrounds the guide rod, the tubular body comprising opposite first and second end portions, wherein the first end portion is secured to the guide rod and the second end portion is secured to the brake pad carrier, wherein the tubular body is configured to longitudinally expand and contract with movement of the guide rod; and
at least one biasing member associated with the tubular body, wherein the at least one biasing member is configured to urge the tubular body to a contracted state.

16. The vehicle disc brake apparatus of claim 15, wherein the at least one biasing member is formed within a wall of the tubular body.

17. The vehicle disc brake apparatus of claim 16, wherein the at least one biasing member comprises at least one spring wire.

18. The vehicle disc brake apparatus of claim 17, wherein the at least one spring wire comprises a plurality of spring wires arranged in substantially equal-spaced intervals around a circumference of the tubular body.

19. The vehicle disc brake apparatus of claim 16, wherein the at least one biasing member comprises spring material that circumferentially surrounds the tubular body and extends from the first end portion to the second end portion.

20. The vehicle disc brake apparatus of claim 15, wherein a portion of the tubular body between the first and second end portions has a varying outer diameter that forms a bellows section.
